(19) United States
(12) Patent Application Publication
(10) Pub. No.: US 2026/0181751 A1
(43) Pub. Date: Jun. 25, 2026

(54) PAN DETECTION FOR MULTI-COIL INDUCTION COOKING APPLIANCE

(71) Applicant: Haier US Appliance Solutions, Inc., Wilmington, DE (US)

(72) Inventors: Marlissa Danielle Sebring, Louisville, KY (US); Ali Jordan Faraji-Tajrishi, Louisville, KY (US); Nathaniel Lehrer, Louisville, KY (US)

(21) Appl. No.: 18/990,043

(22) Filed: Dec. 20, 2024

(51) Int. Cl. H05B 6/12; H05B 6/06

(52) U.S. Cl. CPC H05B 6/1272; H05B 6/065; H05B 2213/05

(57) ABSTRACT

An induction heating system for an induction cooking appliance is provided. The induction heating system includes a plurality of coils operable to inductively heat one or more loads. The induction heating system further includes one or more inverters operable to provide an alternating current. The induction heating system further includes an auxiliary load detection circuit. The induction heating system further includes a plurality of switching devices operable to switch each coil of the plurality of coils from the one or more inverters to the auxiliary load detection circuit. The induction heating system further includes a controller configured to control one or more first switching devices of the plurality of switching devices to operate one or more first coils of the plurality of coils in a test mode, wherein in the test mode, the controller controls the one or more first switching devices to switch the one or more first coils from the one or more inverters to the auxiliary load detection circuit.

### FIELD

Example aspects of the present disclosure relate generally to induction heating systems used, for instance, in induction cooking appliances, and more particularly to determining the presence of a pan associated with a coil of a multi-coil induction cooking appliance.

### BACKGROUND

Induction cooking appliances heat conductive cookware by magnetic induction. An induction cooking appliance applies radio frequency current to an induction heating coil to generate a strong radio frequency magnetic field on the heating coil. When a conductive vessel, such as a load (e.g., a pan), is placed over the heating coil, the magnetic field coupling from the heating coil may generate eddy currents within the vessel, causing the vessel to increase in temperature.

### SUMMARY

Aspects and advantages of embodiments of the present disclosure will be set forth in part in the following description, or can be learned from the description, or can be learned through practice of the embodiments.

One example aspect of the present disclosure is directed to an induction heating system for an induction cooking appliance. The induction heating system includes a plurality of coils operable to inductively heat one or more loads. The induction heating system further includes one or more inverters operable to provide an alternating current. The induction heating system further includes an auxiliary load detection circuit. The induction heating system further includes a plurality of switching devices operable to switch each coil of the plurality of coils from the one or more inverters to the auxiliary load detection circuit. The induction heating system further includes a controller configured to control one or more first switching devices of the plurality of switching devices to operate one or more first coils of the plurality of coils in a test mode, wherein in the test mode, the controller controls the one or more first switching devices to switch the one or more first coils from the one or more inverters to the auxiliary load detection circuit.

Another example aspect of the present disclosure is directed to a method for detecting a load in an induction cooking appliance having a plurality of coils. The method includes operating one or more first coils of the plurality of coils in a test mode, wherein in the test mode the one or more first coils are switched from an inverter to an auxiliary load detection circuit. The method further includes providing, by the auxiliary load detection circuit, a test signal to the one or more first coils in the test mode. The method further includes determining, by the auxiliary load detection circuit, one or more measurement signals based at least in part on the test signal, the one or more measurement signals indicative of one or more load presences of the one or more first coils in the test mode.

Another example aspect of the present disclosure is directed to an induction cooking appliance. The induction cooking appliance includes a user interface comprising one or more user input devices. The induction cooking appliance further includes an induction heating system. The induction heating system includes a plurality of coils operable to inductively heat one or more loads. The induction heating system further includes one or more inverters operable to provide an alternating current. The induction heating system further includes an auxiliary load detection circuit. The induction heating system further includes a plurality of switching devices operable to switch each coil of the plurality of coils from the one or more inverters to the auxiliary load detection circuit. The induction heating system further includes a controller configured to control one or more first switching devices of the plurality of switching devices to operate one or more first coils of the plurality of coils in a test mode, wherein in the test mode, the controller controls the one or more first switching devices to switch the one or more first coils from the one or more inverters to the auxiliary load detection circuit.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 illustrates a perspective view of an example induction cooking appliance according to example embodiments of the present disclosure;

FIG. 2 depicts a block diagram of an example control system for an induction heating appliance according to example embodiments of the present disclosure;

FIG. 3 depicts an example schematic implementation of an induction heating system according to example embodiments of the present disclosure;

FIG. 4 provides a graphical representation of example signals of an auxiliary load detection circuit according to example embodiments of the present disclosure; and

FIG. 5 provides a method for detecting a load associated with a coil in an induction cooking appliance having a plurality of coils.

Repeat use of reference characters in the present specification and drawings is intended to represent the same and/or analogous features or elements of the present invention.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Induction cooking appliances may have induction heating systems configured to heat a load (e.g., a pan, cookware, vessel, etc.). The induction heating system may include a plurality of coils (e.g., induction coils) operable to inductively heat one or more loads with a magnetic field and one or more inverters operable to supply alternating current through the coils. In some induction heating systems with multiple coils supplied from the same inverter, switching devices may be configured to switch the coils between the inverter and a dedicated load (e.g., pan) detection system (e.g., circuit) to determine a presence of the load. However, switching devices with complex relay control may interrupt cooking when switching coils to the inverter, cause contact wear, and generate an audible nuisance due to excessive relay switching. Another challenge for an architecture where multiple switched coils share a single inverter is providing energy to test the load on each coil. For instance, if a first coil and a second coil are both to be powered from the same inverter, it would not be easily feasible to run a load detection check on the first coil, while the second coil is energized by the inverter.

Example aspects of the present disclosure are directed to an auxiliary load detection circuit for a multi-coil induction heating system. The auxiliary load detection circuit includes a single auxiliary switch configured to (e.g., operable to) provide a test signal to each coil of the induction heating system that is in a test mode. Each coil may be independently switched between an inverter and the auxiliary load detection circuit such that a load presence may be determined for some coils supplied by the inverter while other coils supplied by the inverter may be energized to inductively heat a load (e.g., pan). Specifically, a measurement circuit may provide one or more measurement signals based at least in part on the test signal, the one or more measurement signals indicating a load presence of each coil of the plurality of coils in the test mode (e.g., connected to the auxiliary load detection circuit).

Example aspects of the present disclosure provide numerous technical effects and benefits. For instance, the auxiliary load detection circuit of the present disclosure provides a cost-effective solution for load detection on multiple coils sharing a single inverter, or multiple coils distributed across multiple inverters. In addition, a test signal supplied from a singular auxiliary switch that is independent from the alternating voltage supplied by the inverter may allow for more accurate measurement signals indicating the presence of a load.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (e.g., “A or B” is intended to mean “A or B or both”). The term “at least one of” in the context of, e.g., “at least one of A, B, and C” refers to only A, only B, only C, or any combination of A, B, and C. In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

The terms “coupled,” “fixed,” “attached to,” and the like refer to both direct coupling, fixing, or attaching, as well as indirect coupling, fixing, or attaching through one or more intermediate components or features, unless otherwise specified herein.

Except as explicitly indicated otherwise, recitation of a singular processing element (e.g., “a controller,” “a processor,” “a microprocessor,” etc.) is understood to include more than one processing element. In other words, “a processing element” is generally understood as “one or more processing element.” Furthermore, barring a specific statement to the contrary, any steps or functions recited as being performed by “the processing element” or “said processing element” are generally understood to be capable of being performed by “any one of the one or more processing elements.” Thus, a first step or function performed by “the processing element” may be performed by “any one of the one or more processing elements,” and a second step or function performed by “the processing element” may be performed by “any one of the one or more processing elements and not necessarily by the same one of the one or more processing elements by which the first step or function is performed.” Moreover, it is understood that recitation of “the processing element” or “said processing element” performing a plurality of steps or functions does not require that at least one discrete processing element be capable of performing each one of the plurality of steps or functions.

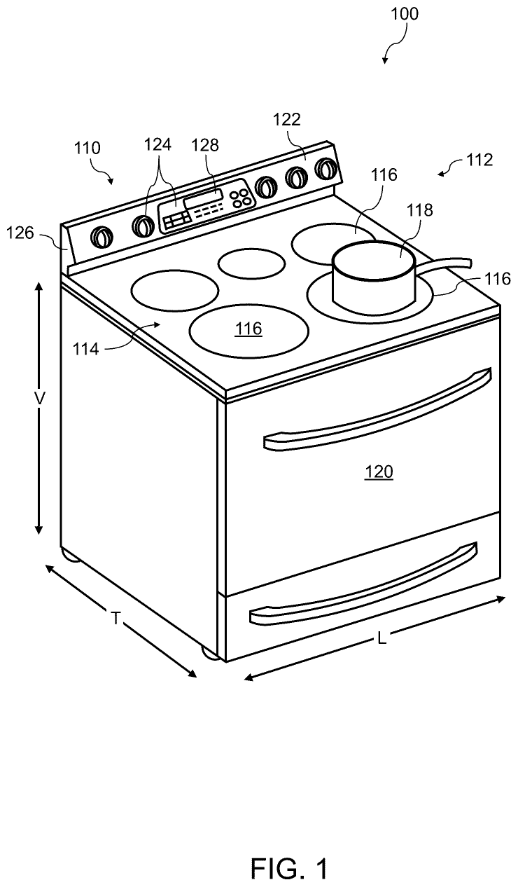

Referring now to the FIGS., FIG. 1 depicts a perspective view of an induction cooking appliance 100. The induction cooking appliance includes a cooktop 112, such as an induction cooktop. Induction cooking appliance 100 is provided by way of example only and is not intended to limit the present subject matter to the arrangement shown in FIG. 1. Thus, the present subject matter may be used with other induction cooking appliances such as oven appliances, single oven range appliances, double oven range appliances, standalone cooktop appliances, cooktop appliances without an oven, etc.

Induction cooking appliance 100 generally defines a vertical direction V, a lateral direction L, and a transverse direction T, each of which is mutually perpendicular, such that an orthogonal coordinate system is generally defined. A cooking surface 114 of cooktop 112 includes a plurality of heating elements 116 (e.g., induction heating elements 116). Heating elements 116 are generally positioned at, e.g., on or proximate to, the cooking surface 114. Each heating element 116 may include one or more induction coils (e.g., coils) configured to (e.g., operable to) inductively heat a load applied to the heating element 116. Cooktop 112 depicts five heating elements 116 spaced along cooking surface 114 for purposes of illustration only. Accordingly, cooktop 112 may include any other suitable shape, configuration, and/or number of heating elements 116. Each of the heating elements 116 may be induction heating elements 116, or cooktop 112 may include a combination of different types of heating elements 116. For example, in various embodiments, the cooktop 112 may include any other suitable type of heating elements 116 in addition to the induction heating element, such as a resistive heating element or gas burners, etc.

In some instances, a cooking zone may correspond to a volume of space in which a load is positioned to be inductively heated by one or more induction heating elements 116. In some embodiments, cooktop 112 may have one or more flexible cooking zones corresponding to one or more of the induction heating elements 116. A flexible cooking zone may be adjusted to conform to the size and/or shape of an object (e.g., load). For instance, a load may be applied to an induction heating element 116. The flexible cooking zone of the induction heating element 116 may be adjusted based at least in part on one or more physical characteristics (e.g., size, shape, etc.) of the load applied to the flexible cooking zone such that the load may be inductively heated. In some embodiments, the induction heating element 116 may include a plurality of coils. Current supplied to the coils may be controlled to adjust the flexible cooking zone.

As shown in FIG. 1, a load 118 (e.g., cooking vessel), such as a pot, pan, or the like, may be placed on an induction heating element 116 to heat the load 118 and cook or heat food items placed in load 118. As will be described below in greater detail, each induction heating element 116 may include one or more coils (e.g., induction coil) operable to inductively heat a load 118. Induction cooking appliance 100 may also include a door 120 that permits access to a cooking chamber (not shown) of induction cooking appliance 100, e.g., for cooking or baking of food items therein. A user interface 122 (e.g., control panel) having controls 124 (e.g., user input devices) may permit a user to make selections for cooking of food items. Although shown on a backsplash or back panel 126 of induction cooking appliance 100, user interface 122 may be positioned in any suitable location. Controls 124 may include buttons, knobs, and the like, as well as combinations thereof, and/or controls 124 may be implemented on a remote user interface device such as a smartphone, tablet, etc. As an example, a user may manipulate one or more controls 124 to select a temperature and/or a heat or power output for each heating element 116. The selected temperature or heat output of heating element 116 affects the heat transferred to load 118 placed on heating element 116. The user interface 122 may also include a display 128.

The induction cooking appliance 100 includes a control system for controlling one or more of the plurality of heating elements 116. Specifically, the control system may include a controller operably coupled to the user interface 122 and the controls 124 and display 128 thereof. The controller may be operably coupled to each of the plurality of heating elements 116 for controlling a heating level each of the plurality of heating elements 116 in response to one or more user inputs received through the user interface 122 and controls 124. The controller may also provide output to the display 128, such as an indication of a selected power level, which heating element(s) 116 is or are activated, etc. Furthermore, as will be discussed in greater detail below, the control system may further be configured to (e.g., operable to) control operation of an induction heating system of the induction cooking appliance 100.

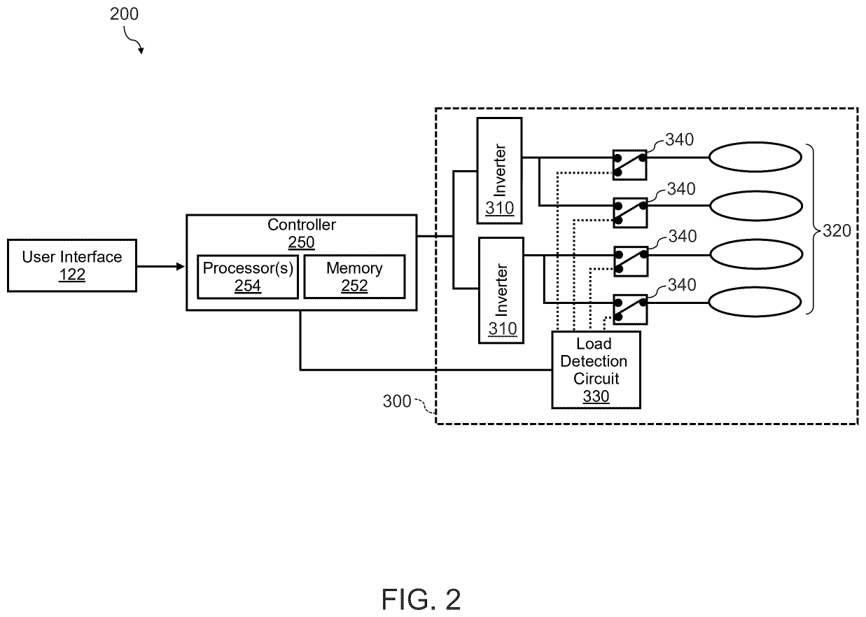

Referring now to FIG. 2, a block diagram of a control system 200 (e.g., heating control system) for an induction cooking appliance is provided. While control system 200 is discussed with reference to induction cooking system 100 of FIG. 1, those of ordinary skill in the art will understand that control system 200 may be used in any suitable cooking system without deviating from the scope of the present disclosure.

As shown in FIG. 2, control system 200 includes an induction heating system 300 configured to (e.g., operable to) inductively heat one or more loads (e.g., pans). Specifically, inverters 310, switching devices 340, induction coils 320, and auxiliary load detection circuit 330 may be defined as an induction heating system 300. Coils 320 are operable to heat a load when supplied with an alternating current. One or more inverters 310 are operable to provide the alternating current to each coil 320 of the plurality of coils 320. In some embodiments, coils 320 may create flexible cooking zones that can conform to the size and/or shape of an object. In some embodiments, each coil of the plurality of coils 320 may correspond to a heating element, such as heating element 116 (FIG. 1). Alternatively, multiple coils of the plurality of coils 320 may correspond to the same heating element. For example, multiple coils may be configured to (e.g., operable to) heat a singular load applied to a heating element.

Inverters 310 may receive power from a power supply circuit. The power supply circuit may include rectification circuitry for rectifying power from an alternating current (AC) supply, which may provide conventional 60 Hz 120 or 240 volt AC supplied by utility companies. In addition, the power supply circuit may include filtering and power factor correction circuitry to filter the power received and noise emitted by the inverters 310. In some embodiments, each inverter 310 of the control system 200 may receive power from the same AC supply.

Induction heating system 300 further includes an auxiliary load detection circuit 330. The auxiliary load detection circuit 330 is configured to (e.g., operable to) determine measurement signals indicating a load presence of each coil 320 of the plurality of coils 320. For example, control system 200 may further include a plurality of switching devices 340 corresponding to each coil 320. Each switching device 340 is operable to switch a coil 320 between an inverter 310 and the auxiliary load detection circuit 330. Each switching device 340 may be, for instance, a relay.

When connected (e.g., via switching devices 340) to a coil 320, the auxiliary load detection circuit 330 is configured to (e.g., operable to) determine a measurement signal indicating the presence of a load (e.g., load presence) of the coil 320. Auxiliary load detection circuit 330 may be connected to any combination of coils 320 simultaneously, such that measurement signals may be determined from each coil connected to the auxiliary load detection circuit 330 via switching devices 340.

Specifically, auxiliary load detection circuit 330 may include an auxiliary power switch configured to (e.g., operable to) provide a test signal to each coil 320 that is connected to the auxiliary load detection circuit 330. One or more measurement signals may be determined based at least in part on the test signal provided by the auxiliary power switch. The one or more measurement signals determined by auxiliary load detection circuit 330 may be indicative of a load presence of the coils 320.

While induction heating system 300 as shown in FIG. 2 illustrates two inverters 310 supplying four induction coils 320 (e.g., two coils 320 per inverter 310), those of ordinary skill in the art will understand that other inverter-coil configurations may be implemented without deviating from the scope of the present embodiment. For example, an induction heating system of control system 200 may include any number of inverters 310 configured to (e.g., operable to) supply the plurality of coils 320. In addition, each inverter 310 may be operable to supply two or more coils 320. In some embodiments, each inverter 310 of induction heating system 300 is a half-bridge inverter. Accordingly, induction heating system 300 may include a plurality of half-bridge inverters 310.

In some embodiments, control system 200 further includes a controller 250 operatively coupled to each inverter 310 of the plurality of inverters 310. Specifically, controller 250 may be configured to (e.g., operable to) control the power of inductions coil 320 by controlling the switching frequency of inverters 310. Controller 250 may include one or more microcontrollers and/or gate drivers to drive individual transistors or switching devices of inverters 310 with pulse-width modulated signals. Controller 250 may include memory 252 and one or more processors 254 such as microprocessors, CPUs or the like, such as general or special purpose microprocessors operable to execute programming instructions or micro-control code associated with operation of induction heating system 300. Memory 252 may represent random access memory such as DRAM, or read only memory such as ROM or FLASH. In one embodiment, the processor 254 executes programming instructions stored in memory 252. Memory 252 may be a separate component from controller 250 or may be included onboard controller 250.

In some embodiments, controller 250 is configured to (e.g., operable to) control one or more first switching devices 340 to operate one or more coils associated with the one or more switching devices 340 in a test mode. In the test mode, the controller 250 may control one or more of the switching devices 340 to switch the one or more coils associated with the switching devices 340 to the auxiliary load detection circuit 330. Accordingly, a coil of the plurality of coils 320 may be switched from an inverter 310 to the auxiliary load detection circuit 330 when in the test mode. In some embodiments, controller 250 is further configured to (e.g., operable to) determine one or more load presences of the one or more first coils in the test mode based at least in part on a test signal provided to the one or more first coils in the test mode. In addition, controller 250 may be further configured to (e.g., operable to) control the one or more first switching devices to switch the one or more first coils from the auxiliary load detection circuit 330 to the one or more inverters 310 based at least in part on the one or more load presences of the one or more first coils.

Auxiliary load detection circuit 330 may be coupled to controller 250. Auxiliary load detection circuit 330 may provide the one or more measurement signals to the controller 250. As such, controller 250 may be configured to (e.g., operable to) determine the load presence of a coil 320 based at least in part on the measurement signal.

In some embodiments, controller 250 or other control device may be configured to (e.g., operable to) control switching devices 340 to switch the coil from the auxiliary load detection circuit 330 to an inverter 310 based at least in part on the load presence of the coil. For example, a coil may be switched to an inverter 310 to be energized when a load has been detected based at least in part on a measurement signal provided by auxiliary load detection circuit 330.

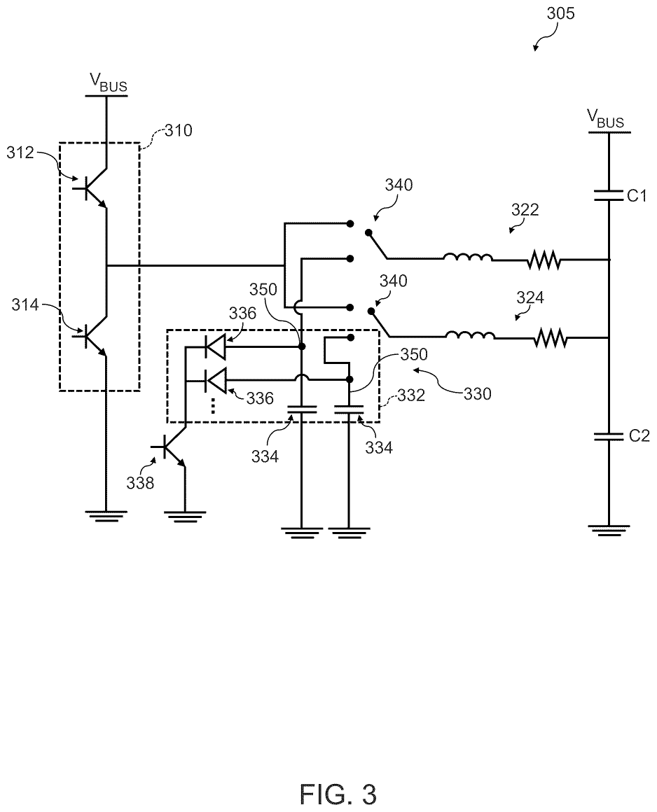

Referring now to FIG. 3, a circuit schematic of an example induction heating system 305 according to example embodiments of the present disclosure is provided. An induction heating system may be used in an control system, such as control system 200 of FIG. 2 for application in an induction cooking appliance, such as induction cooking appliance 100 as shown in FIG. 1. For purposes of illustration, induction heating system 305 of FIG. 3 depicts a single inverter 310 operable to supply alternating current to two induction coils 322, 324. In some embodiments, induction coils 322, 324 may be correspond to one or more flexible cooking zones. In addition, induction coils 322, 324 may be included in a plurality of coils, such as the plurality of coils 320 depicted in FIG. 2. For example, the plurality of coils 320 of induction heating system 300 depicted in FIG. 2 may include coils 322, 324 as shown in FIG. 3. Those of ordinary skill in the art will understand that the induction heating system 305 of FIG. 3 may be implemented with other inverter-coil configurations such as the two-inverter system depicted in FIG. 2, with a plurality of inverters 310 supplying alternating current to two coils 320 (FIG. 2) each. Furthermore, those of ordinary skill in the art will understand that induction heating system 305 of FIG. 3 may include any number of induction coils supplied by inverter 310.

As shown in FIG. 3, inverter 310 may be a half-bridge inverter. For instance, inverter 310 may include two inverter switching devices (e.g., high-side inverter switching device 312 and low-side inverter switching device 314). Inverter switching devices 312, 314 are configured to (e.g., operable to) provide alternating current to energize the induction heating coils 322, 324 at a desired frequency. In some embodiments, inverter switching devices 312, 314 may be Insulated-Gate Bipolar Transistors (e.g., IGBTs). However, other suitable switching devices (e.g., MOSFETs) may be used without deviating from the scope of the present disclosure. Inverter switching devices 312, 314 may be controlled by a controller (e.g., gate driver circuitry of a controller), such as controller 250 depicted in FIG. 2. In some embodiments, both inverter switching devices 312, 314 may be configured in parallel with a capacitor (not shown). In addition, induction heating system 305 may include one or more resonant capacitors (e.g., C1 and C2). The one or more resonant capacitors may include a high-side resonant capacitor C1 and a low-side resonant capacitor C2. Induction heating system 305 may receive power at V_{BUS}. Induction coils 322, 324 and, if present a load, may be represented in FIG. 3 as an inductor and a resistor.

Switching devices 340 are coupled between inverter 310 and each coil 322, 324. As shown, switching devices 340 are operable to switch coils 322, 324 from inverter 310 to auxiliary load detection circuit 330. In some embodiments, each switching device 340 may be a relay. In addition, each switching device 340 may be switched independently from other switching devices 340. For example, a first switching device 340 may connect coil 322 to inverter 310 while a second switching device 340 may connect a second coil 324 to auxiliary load detection circuit 330. In this manner, load detection on some coils may be performed while other coils are energized by the inverter 310.

For example, a controller such as controller 250 depicted in FIG. 2 may control a first switching device 340 to operate coil 322 in a test mode. In the test mode, the controller may control the first switching device 340 to switch coil 322 from inverter 310 to auxiliary load detection circuit 330. While coil 322 is in the test mode, the controller may control a second switching device 340 to maintain coil 324 to receive the alternating current from the inverter 310. Accordingly, the controller may determine a load presence of coil 322 in the test mode while coil 324 is energized by inverter 310.

Auxiliary load detection circuit 330 may include an auxiliary power switch 338 and a measurement circuit 332. Auxiliary power switch 338 is configured to (e.g., operable to) provide a test signal to each coil 322, 324 that is in the test mode (e.g., connected to measurement circuit 332 (e.g., via switching devices 340)). In some embodiments, auxiliary power switch 338 may be an Insulated-Gate Bipolar Transistors (e.g., IGBTs). However, other suitable switching devices (e.g., MOSFETs) may be used without deviating from the scope of the present disclosure. Auxiliary power switch 338 may be controlled by a controller, such as controller 250 depicted in FIG. 2, to provide the test signal. For instance, a controller may provide a signal to the gate of auxiliary power switch 338, switching the auxiliary power switch 338 to an ON state and providing the test signal to coils in the test mode.

Measurement circuit 332 is operable to provide one or more measurement signals indicating a load presence of each coil 322, 324. For example, measurement circuit 332 may include a plurality of measurement capacitors 334. As shown, each measurement capacitor 334 may be associated with (e.g., independently coupled to) a coil 322, 324. A plurality of measurement nodes 350 may be defined between each measurement capacitor 334 and the corresponding coil 322, 324 (e.g., corresponding switching device 340 of coils 322, 324). In some embodiments, the one or more measurement signals may indicate a voltage at one or more measurement nodes 350 of the measurement circuit 332.

Each measurement capacitor 334 may be coupled between a coil 322, 324 and the auxiliary power switch 338 (e.g., via switching device 340). Specifically, measurement circuit 332 may include a measurement capacitor 334 corresponding to each coil 322, 324 of the induction heating system 305. In addition, measurement circuit 332 may further include a plurality of diodes 336 operably coupled between auxiliary power switch 338 and each coil 322, 324 (e.g., measurement node 350 of each coil 322, 324) such that a measurement signal generated from one coil does not interfere with the measurement signal generated from another coil. When in the test mode a coil 322, 324 may be connected to auxiliary power switch 338 of auxiliary load detection circuit 330 via a diode 336.

Each measurement capacitor 334 may have a capacitance (e.g., known capacitance), such that an equivalent inductance of a coil may be calculated from the resonant frequency of the network. The equivalent inductance of the coil 322, 324 may vary with the presence of a load on the coil 322, 324, such that the load presence of a coil 322, 324 may be determined based at least in part on a measurement signal and a capacitance associated with the measurement capacitor.

In some embodiments, controller 250 (FIG. 2) may be configured to (e.g., operable to) receive the one or more measurement signals from auxiliary load detection circuit 330. For example, controller 250 may be operably coupled to the plurality of measurement nodes 350. A scaling circuit may be configured to (e.g., operable to) scale the one or more measurement signals to appropriate values acceptable to the controller 250. Accordingly, the controller 250 or other processing device may be configured to (e.g., operable to) determine a load presence of coils 322, 324 based at least in part on the one or more measurement signals provided by the auxiliary load detection circuit 330. In additional embodiments, the capacitance (e.g., known capacitance) of each measurement capacitor 334 may be saved by controller 250 in, for instance memory 252. As such, controller 250 may determine a load presence of a coil 320 based at least in part on a measurement signal and a capacitance associated with the measurement capacitor when the coil is in the test mode.

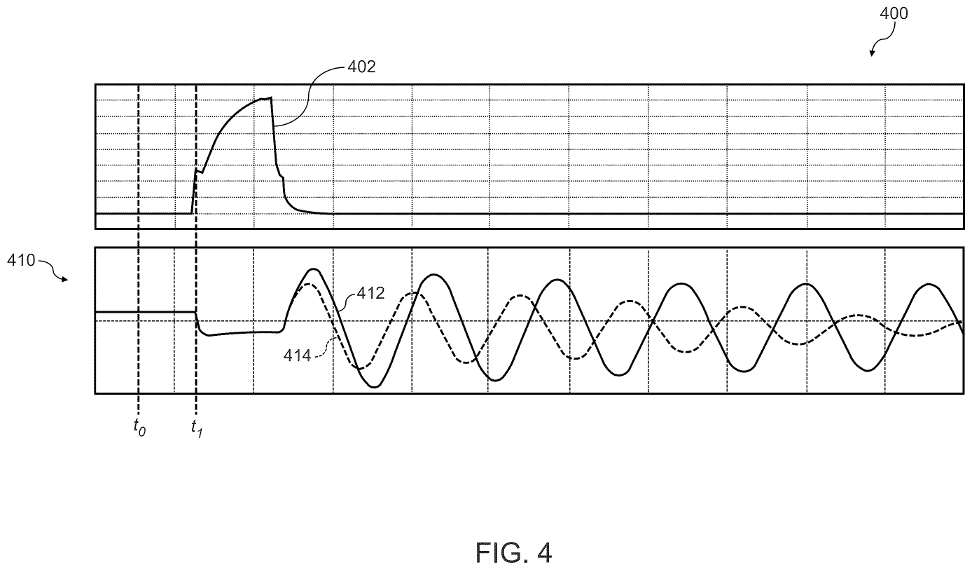

FIG. 4 provides a graphical representation of example signals of an auxiliary load detection circuit according to example embodiments of the present disclosure. Specifically, the example signals of FIG. 4 are discussed with reference to the auxiliary load detection circuit 330 as described with reference to FIGS. 2 and 3.

Specifically, plot 400 illustrates an example signal 402 provided to a gate of auxiliary power switch 338 (FIG. 3). When signal 402 is provided to the auxiliary power switch, a test signal may be provided to each coil of a plurality of coils that is in the test mode (e.g., switched to the auxiliary load detection circuit 330 via switching devices 340). For instance, signal 402 may switch auxiliary power switch 338 (FIG. 3) to an ON state, providing the test signal to each coil of the plurality of coils or a subset of the plurality of coils that are switched to the auxiliary load detection circuit 330. Signal 402 may be provided to auxiliary power switch 338 (FIG. 3) by a controller, such as controller 250 depicted in FIG. 2. Plot 410 illustrates example measurement signals 412, 414 provided by measurement circuit 332. In some embodiments, example measurement signals 412, 414 may be defined as voltage signal representations of voltages applied to measurement nodes 350.

As shown at t₀, measurement signals 412, 414 are constant (e.g., not oscillating). Beginning at t₁, test signal 402 is applied. In response, measurement signals 412, 414 may begin to oscillate. As illustrated in plot 410 of FIG. 4, measurement signal 414 may depict a measurement signal of a coil that is associated with a load, while measurement signal 412 depicts a measurement signal of a coil that is not associated with a load. As shown, a load presence of each coil of a plurality of coils in the test mode may be determined based on the measurement signals 412, 414.

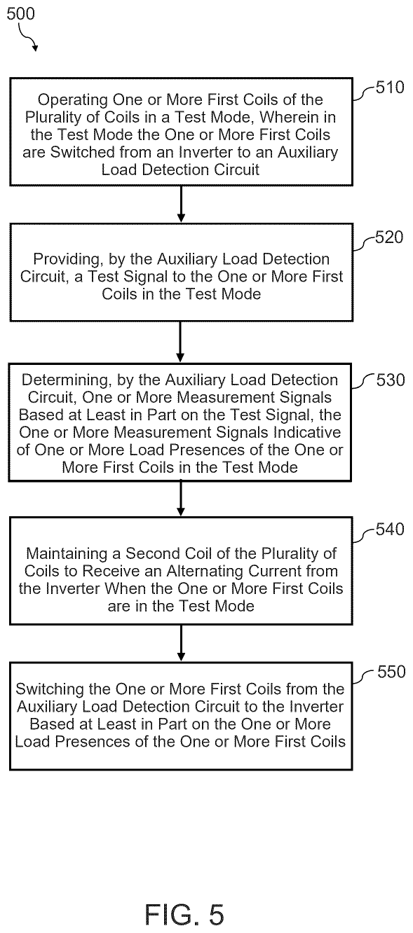

Referring now to FIG. 5, a method 500 for detecting a load in an induction cooking appliance having a plurality of coils is provided. While method 500 is described with reference to control system 200 of FIG. 2 and the induction heating system 305 of FIG. 3, those of ordinary skill in the art will understand that method 500 may be implemented in any applicable induction heating system and/or induction cooking appliance. Method 500 provides a series of steps performed in a particular order for purposes of illustration and discussion. Those of ordinary skill in the art, using the disclosures provided herein, will understand that any step of method 500 discussed herein can be adapted, rearranged, expanded, omitted, or modified in various ways without deviating from the scope of the present disclosure.

At (510) method 500 includes operating one or more first coils of the plurality of coils in a test mode, wherein in the test mode the one or more first coils are switched from an inverter to an auxiliary load detection circuit. For example, a first coil such as coil 322 (FIG. 3) of a plurality of coils may be operated in a test mode. When in the test mode, coil 322 may be switched from inverter 310 to auxiliary load detection circuit 330.

At (520) method 500 includes providing, by the auxiliary load detection circuit, a test signal to the one or more first coils in the test mode. For example, auxiliary power switch 338 of auxiliary load detection circuit 330 may provide a test signal to coil 322 when the coil is in the test mode (e.g., switched to the auxiliary load detection circuit 330).

At (530) method 500 includes determining, by the auxiliary load detection circuit, one or more measurement signals based at least in part on the test signal, the one or more measurement signals indicative of one or more load presences of the one or more first coils in the test mode. For example, measurement circuit 332 of auxiliary load detection circuit 330 may determine a measurement signal such as example measurement signals 412, 414 provided in FIG. 4 based at least in part on the example test signal 402.

In some embodiments, method 500 may include, at (540), maintaining a second coil of the plurality of coils to receive an alternating current from the inverter when the one or more first coils are in the test mode. For example, controller 250 may maintain coil 324 of the plurality of coils to receive alternating current from inverter 310 when coil 322 is in the test mode. Accordingly, load detection of coil 322 may be performed while coil 324 is energized by inverter 310.

In some embodiments, method 500 may include, at (550), switching the one or more first coils from the auxiliary load detection circuit to the inverter based at least in part on the one or more load presences of the one or more first coils. For example, controller 250 may be configured to (e.g., operable to) determine a load presence of a coil such as coil 322 based at least in part on a measurement signal. Controller 250 may be further configured to (e.g., operable to) control the associated switching device 340 to switch coil 322 from the auxiliary load detection circuit 330 to the inverter 310 based at least in part on the load presence determined for coil 322.

One example aspect of the present disclosure is directed to an induction heating system for an induction cooking appliance. The induction heating system includes a plurality of coils operable to inductively heat one or more loads. The induction heating system further includes one or more inverters operable to provide an alternating current. The induction heating system further includes an auxiliary load detection circuit. The induction heating system further includes a plurality of switching devices operable to switch each coil of the plurality of coils from the one or more inverters to the auxiliary load detection circuit. The induction heating system further includes a controller configured to control one or more first switching devices of the plurality of switching devices to operate one or more first coils of the plurality of coils in a test mode, wherein in the test mode, the controller controls the one or more first switching devices to switch the one or more first coils from the one or more inverters to the auxiliary load detection circuit.

In some examples, the controller is further configured to control a second switching device of the plurality of switching devices to maintain a second coil of the plurality of coils to receive the alternating current from the one or more inverters when the one or more first coils are in the test mode.

In some examples, the controller is further configured to determine one or more load presences of the one or more first coils in the test mode based at least in part on a test signal provided to the one or more first coils by the auxiliary load detection circuit.

In some examples, the controller is further configured to control the one or more first switching devices to switch the one or more first coils from the auxiliary load detection circuit to the one or more inverters based at least in part on the one or more load presences of the one or more first coils.

In some examples, the one or more first coils comprises a plurality of first coils, the controller configured to determine a plurality of load presences of the plurality of first coils in the test mode based at least in part on a test signal provided to the plurality of first coils by the auxiliary load detection circuit.

In some examples, the one or more first coils are connected to an auxiliary power switch of the auxiliary load detection circuit via a diode when in the test mode.

In some examples, the plurality of coils corresponds to one or more flexible cooking zones.

In some examples, the one or more inverters comprises a half-bridge inverter.

In some examples, the one or more inverters comprises a plurality of half-bridge inverters.

Another example aspect of the present disclosure is directed to a method for detecting a load in an induction cooking appliance having a plurality of coils. The method includes operating one or more first coils of the plurality of coils in a test mode, wherein in the test mode the one or more first coils are switched from an inverter to an auxiliary load detection circuit. The method further includes providing, by the auxiliary load detection circuit, a test signal to the one or more first coils in the test mode. The method further includes determining, by the auxiliary load detection circuit, one or more measurement signals based at least in part on the test signal, the one or more measurement signals indicative of one or more load presences of the one or more first coils in the test mode.

In some examples, the method further includes maintaining a second coil of the plurality of coils to receive an alternating current from the inverter when the one or more first coils are in the test mode.

In some examples, the inverter comprises a half-bridge inverter.

In some examples, the one or more first coils in the test mode comprises a plurality of first coils in the test mode.

In some examples, the plurality of coils corresponds to one or more flexible cooking zones.

In some examples, the method further includes switching the one or more first coils from the auxiliary load detection circuit to the inverter based at least in part on the one or more load presences of the one or more first coils.

Another example aspect of the present disclosure is directed to an induction cooking appliance. The induction cooking appliance includes a user interface comprising one or more user input devices. The induction cooking appliance further includes an induction heating system. The induction heating system includes a plurality of coils operable to inductively heat one or more loads. The induction heating system further includes one or more inverters operable to provide an alternating current. The induction heating system further includes an auxiliary load detection circuit. The induction heating system further includes a plurality of switching devices operable to switch each coil of the plurality of coils from the one or more inverters to the auxiliary load detection circuit. The induction heating system further includes a controller configured to control one or more first switching devices of the plurality of switching devices to operate one or more first coils of the plurality of coils in a test mode, wherein in the test mode, the controller controls the one or more first switching devices to switch the one or more first coils from the one or more inverters to the auxiliary load detection circuit.

In some examples, the controller is further configured to control a second switching device of the plurality of switching devices to maintain a second coil of the plurality of coils to receive the alternating current from the one or more inverters when the one or more first coils are in the test mode.

In some examples, the controller is further configured to determine one or more load presences of the one or more first coils in the test mode based at least in part on a test signal provided to the one or more first coils by the auxiliary load detection circuit.

In some examples, the controller is further configured to control the one or more first switching devices to switch the one or more first coils from the auxiliary load detection circuit to the one or more inverters based at least in part on the one or more load presences of the one or more first coils.

In some examples, the one or more inverters comprises a plurality of half-bridge inverters.

While the present subject matter has been described in detail with respect to specific example embodiments thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. An induction heating system for an induction cooking appliance, comprising:
a plurality of coils operable to inductively heat one or more loads;
one or more inverters operable to provide an alternating current;
an auxiliary load detection circuit;
a plurality of switching devices operable to switch each coil of the plurality of coils from the one or more inverters to the auxiliary load detection circuit; and
a controller configured to control one or more first switching devices of the plurality of switching devices to operate one or more first coils of the plurality of coils in a test mode, wherein in the test mode, the controller controls the one or more first switching devices to switch the one or more first coils from the one or more inverters to the auxiliary load detection circuit.

2. The induction heating system of claim 1, wherein the controller is further configured to control a second switching device of the plurality of switching devices to maintain a second coil of the plurality of coils to receive the alternating current from the one or more inverters when the one or more first coils are in the test mode.

3. The induction heating system of claim 1, wherein the controller is further configured to determine one or more load presences of the one or more first coils in the test mode based at least in part on a test signal provided to the one or more first coils by the auxiliary load detection circuit.

4. The induction heating system of claim 3, wherein the controller is further configured to control the one or more first switching devices to switch the one or more first coils from the auxiliary load detection circuit to the one or more inverters based at least in part on the one or more load presences of the one or more first coils.

5. The induction heating system of claim 1, wherein the one or more first coils comprises a plurality of first coils, the controller configured to determine a plurality of load presences of the plurality of first coils in the test mode based at least in part on a test signal provided to the plurality of first coils by the auxiliary load detection circuit.

6. The induction heating system of claim 1, wherein the one or more first coils are connected to an auxiliary power switch of the auxiliary load detection circuit via a diode when in the test mode.

7. The induction heating system of claim 1, wherein the plurality of coils corresponds to one or more flexible cooking zones.

8. The induction heating system of claim 1, wherein the one or more inverters comprises a half-bridge inverter.

9. The induction heating system of claim 1, wherein the one or more inverters comprises a plurality of half-bridge inverters.

10. A method for detecting a load in an induction cooking appliance having a plurality of coils, the method comprising:
operating one or more first coils of the plurality of coils in a test mode, wherein in the test mode the one or more first coils are switched from an inverter to an auxiliary load detection circuit;
providing, by the auxiliary load detection circuit, a test signal to the one or more first coils in the test mode; and
determining, by the auxiliary load detection circuit, one or more measurement signals based at least in part on the test signal, the one or more measurement signals indicative of one or more load presences of the one or more first coils in the test mode.

11. The method of claim 10, further comprising:
maintaining a second coil of the plurality of coils to receive an alternating current from the inverter when the one or more first coils are in the test mode.

12. The method of claim 10, wherein the inverter comprises a half-bridge inverter.

13. The method of claim 10, wherein the one or more first coils in the test mode comprises a plurality of first coils in the test mode.

14. The method of claim 10, wherein the plurality of coils corresponds to one or more flexible cooking zones.

15. The method of claim 10, further comprising:
switching the one or more first coils from the auxiliary load detection circuit to the inverter based at least in part on the one or more load presences of the one or more first coils.

16. An induction cooking appliance, comprising:
a user interface comprising one or more user input devices; and
an induction heating system comprising:
a plurality of coils operable to inductively heat one or more loads;
one or more inverters operable to provide an alternating current;
an auxiliary load detection circuit;
a plurality of switching devices operable to switch each coil of the plurality of coils from the one or more inverters to the auxiliary load detection circuit; and
a controller configured to control one or more first switching devices of the plurality of switching devices to operate one or more first coils of the plurality of coils in a test mode, wherein in the test mode, the controller controls the one or more first switching devices to switch the one or more first coils from the one or more inverters to the auxiliary load detection circuit.

17. The induction cooking appliance of claim 16, wherein the controller is further configured to control a second switching device of the plurality of switching devices to maintain a second coil of the plurality of coils to receive the alternating current from the one or more inverters when the one or more first coils are in the test mode.

18. The induction cooking appliance of claim 16, wherein the controller is further configured to determine one or more load presences of the one or more first coils in the test mode based at least in part on a test signal provided to the one or more first coils by the auxiliary load detection circuit.

19. The induction cooking appliance of claim 18, wherein the controller is further configured to control the one or more first switching devices to switch the one or more first coils from the auxiliary load detection circuit to the one or more inverters based at least in part on the one or more load presences of the one or more first coils.

20. The induction cooking appliance of claim 16, wherein the one or more inverters comprises a plurality of half-bridge inverters.
